(19) United States
(12) Patent Application Publication
(10) Pub. No.: US 2013/0050027 A1
(43) Pub. Date: Feb. 28, 2013

(54) MIMO/DIVERSITY ANTENNA WITH HIGH ISOLATION

(71) Applicants: Tae-Hyung KIM, Gyeonggi-do (KR); Ki-Hyun KONG, Gyeonggi-do (KR); Je-Min LEE, Gyeonggi-do (KR); Byung-Je LEE, Seoul (KR); Byeong-Kwan KIM, Seoul (KR); Hyun-Ho WI, Seoul (KR); Bong-Gyu SHIN, Gyeonggi-do (KR)

(72) Inventors: Tae-Hyung KIM, Gyeonggi-do (KR); Ki-Hyun KONG, Gyeonggi-do (KR); Je-Min LEE, Gyeonggi-do (KR); Byung-Je LEE, Seoul (KR); Byeong-Kwan KIM, Seoul (KR); Hyun-Ho WI, Seoul (KR); Bong-Gyu SHIN, Gyeonggi-do (KR)

(73) Assignee: LS Mtron Ltd., Gyeonggi-do (KR)

(21) Appl. No.: 13/530,493

(22) Filed: Jun. 22, 2012

(30) Foreign Application Priority Data
Aug. 29, 2011 (KR) 10-2011-0086616

(51) Int. Cl. H01Q 9/04

(52) U.S. Cl. 343/700 MS

(57) ABSTRACT

Disclosed is a MIMO/diversity antenna high isolation including a printed circuit board, a plurality of antenna elements, a current conversion element connected with a common ground of the printed circuit board apart from the antenna elements at a predetermined distance, wherein the current conversion element is coupled with the antenna elements to induce an electric current from the antenna elements into the antenna elements again via the common ground.

### CROSS-REFERENCE TO RELATED APPLICATION(S)

This application claims priority from Korean Patent Application No. 10-2011-0086616, filed on Aug. 29, 2011, the entire disclosure of which is incorporated herein by reference for all purposes.

### BACKGROUND

1. Field

Exemplary embodiments relate to a MIMO/diversity antenna, and more particularly, to a MIMO/diversity antenna with improved isolation for a mobile communication terminal of a narrow space.

2. Description of the Related Art

Conventionally, a mobile communication system employs a single antenna or a built-in and external mixed antenna. However, to meet the demands of the recently trendy minimized and attractive mobile communication terminals, built-in antennas are preferred. Also, with the increasing demand for a high speed multimedia service using a wireless mobile communication technology, channel capacity in a mobile communication system tends to rapidly increase. Accordingly, interests in an antenna technology for a broadband mobile communication system satisfying minimization, increased channel capacity, and transmission reliability are increasing.

In this context, an antenna technology using multiple-input and multiple-output (MIMO) or diversity is gaining attention these days.

The MIMO antenna technology uses two or more antennas at each base station and mobile communication terminal in carrying data and receiving and detecting signals. The antenna diversity technology receives a signal wave using two or more antennas and detects the signal by combining the output of the signal. Accordingly, a MIMO/diversity antenna improves the transmission reliability and overcomes the limitations in transmission rate confronted by the expansion of data communication.

However, a mobile communication terminal with a MIMO/diversity antenna experiences the mutual coupling between antennas due to the spatial limitation of the mobile communication terminal, resulting in reduced isolation.

To solve this problem, suggestions have been made to isolate antennas at a distance of λ/2 or more where λ is the wavelength of signals emitted from the antennas. However, because a built-in antenna has a limitation in installation space, simply isolating antennas is not a sufficient solution.

To improve the isolation of a MIMO/diversity antenna, for example, Korean Patent Publication No. 2010-0097774 discloses a MIMO antenna having a rear surface formed with parasitic elements that operate in the 2.4 GHz band. According to this art, parasitic elements having an electrical length of λ/2 are spaced apart from the antenna elements at a predetermined distance or more and a bridge connects the parasitic elements to induce an electric current thereinto, thereby improving the isolation of the antenna.

However, there are drawbacks in that the parasitic elements used for isolation improvement have a relatively large size of λ/2 and do not operate in the low frequency range where a state-of-the-art next-generation wireless communication service, such as, for example, long term evolution (LTE) is provided.

### SUMMARY OF THE INVENTION

The present invention is designed to solve the above problems, and therefore it is an object of the present invention to provide a MIMO/diversity antenna with high isolation, including a current conversion device for changing an electric current distribution on antenna elements and a ground, thereby improving the isolation and the correlation between the antenna elements through improvement in the antenna pattern and achieving the minimization, so that the MIMO/diversity antenna can be implemented in a narrow internal space of a mobile communication terminal on the low frequency bands.

Additional features of the invention will be set forth in the description which follows, and in part will be apparent from the description, or may be learned by practice of the invention.

According to an aspect of the present invention, provided is a MIMO/diversity antenna including a printed circuit board, a plurality of antenna elements, a current conversion element connected with a common ground of the printed circuit board apart from the antenna elements at a predetermined distance, wherein the current conversion element is coupled with the antenna elements to induce an electric current from the antenna elements into the antenna elements again via the common ground.

Preferably, each of a plurality of the antenna elements includes a power line connected with a power supply located at the end of the printed circuit board, a ground line connected with a ground located on the common ground of the printed circuit board, and an antenna pattern connected with the power line and the ground line to radiate an electromagnetic wave to the outside.

Preferably, the antenna pattern is formed by at least one bending and has an end located at the end of the printed circuit board.

Preferably, the end of the antenna pattern is arranged parallel to the ground lines of the antenna elements on the same or different plane.

Preferably, each of a plurality of the antenna elements has a length equal to one fourth of a wavelength λ at the center frequency of the operating frequency range of the antenna.

Preferably, a plurality of the antenna elements are symmetrical and spaced apart from each other at a distance equal to at least one twentieth of a wavelength λ at the center frequency of the operating frequency range of the antenna.

Preferably, the current conversion element includes a current coupling pattern coupled with the antenna elements, and a current ground line to connect the current coupling pattern with the common ground of the printed circuit board.

Preferably, the current coupling pattern is partially bent and parallel to the antenna patterns of the antenna elements.

Preferably, the current coupling pattern partially overlaps with the antenna patterns of the antenna elements on the same or different plane.

Preferably, the current ground line is parallel to the ground lines of the antenna elements.

Preferably, the current ground line meanders.

Preferably, the antenna elements and the current conversion element are connected with the same surface of the printed circuit board, or the antenna elements are connected with one surface of the printed circuit board and the current conversion element is connected with the other surface of the printed circuit board.

Preferably, the current conversion element has a length equal to one tenth to one twentieth of a wavelength λ at the center frequency of the operating frequency range of the antenna.

Preferably, a plurality of the antenna elements and the current conversion element are formed in the space or formed and fixed on a dielectric block having a predetermined dielectric constant.

According to another aspect of the present invention, provided is a MIMO/diversity antenna including a printed circuit board, a first antenna element located at one end of the printed circuit board, a second antenna element located at the other end of the printed circuit board, and a current conversion element connected with a common ground of the printed circuit board and located between the first and second antenna elements apart from the first and second antenna elements at a predetermined distance and, wherein the current conversion element is coupled with the first and second antenna elements to induce an electric current from the first and second antenna elements into the first and second antenna elements again via the common ground.

Preferably, the first and second antenna elements are symmetrical relative to the current conversion element and the current conversion element is formed in the shape of ‘T’.

Preferably, the first and second antenna elements include power lines located at the opposite ends of the printed circuit board, and ground lines located between the power lines of the first and second antenna elements.

According to still another aspect of the present invention, a MIMO/diversity antenna including a printed circuit board, a first antenna element located at one side of the printed circuit board, a second antenna element located at the other side of the printed circuit board, and a current conversion element connected with a common ground of the printed circuit board and individually provided to each of the first and second antenna elements apart from the first and second antenna elements at a predetermined distance and, wherein the current conversion element is coupled with the first and second antenna elements to induce an electric current from the first and second antenna elements into the first and second antenna elements again via the common ground.

Preferably, the first and second antenna elements are symmetrical relative to the current conversion element and the current conversion element is formed in the shape of a bar bent at a right angle.

Preferably, the first and second antenna elements include power lines located at the ends of the opposite sides of the printed circuit board, and ground lines located closer to the inside than the power lines.

### EFECT OF THE INVENTION

According to the present invention, the MIMO/diversity antenna uses the current conversion element to change an electric current distribution on the antenna elements and the ground, and may improve the isolation and correlation between the antenna elements through improvement in the antenna pattern, thereby preventing the characteristics of the antenna from deteriorating. Also, the MIMO/diversity antenna can achieve the minimization suitable for a mobile communication terminal of a narrow internal space. Furthermore, the MIMO/diversity antenna can operate in a general communication band and the low frequency range as well where a state-of-the-art next-generation wireless communication service, such as, for example, long term evolution (LTE) is provided.

### BRIEF DESCRIPTION OF THE DRAWINGS

The accompanying drawing illustrates a preferred embodiment of the present disclosure and together with the foregoing disclosure, serves to provide further understanding of the technical spirit of the present disclosure. However, the present disclosure is not construed as being limited to the drawing.

FIG. 1 is a perspective view illustrating a MIMO/diversity antenna with high isolation according to an embodiment of the present invention.

FIG. 2 is a perspective view illustrating a MIMO/diversity antenna with high isolation according to another embodiment of the present invention.

FIG. 3 is a view illustrating an electric current distribution over a MIMO/diversity antenna with high isolation according to an embodiment of the present invention.

FIG. 4 is a view illustrating a 3-dimensional radiation pattern for a MIMO/diversity antenna with high isolation according to an embodiment of the present invention.

FIG. 5 is a view illustrating an electric current distribution on antenna elements and a current conversion element according to the present invention.

FIGS. 6 and 7 are plane views illustrating modified examples of an electric current distribution according to the present invention.

### DESCRIPTION OF THE PREFERRED EMBODIMENT

The present invention will now be described in detail with reference to the accompanying drawings. Prior to description, it should be understood that terms and words used in the specification and the appended claims should not be construed as having common and dictionary meanings, but should be interpreted as having meanings and concepts corresponding to technical ideas of the present invention in view of the principle that the inventor can properly define the concepts of the terms and words in order to describe his/her own invention as best as possible. Accordingly, the description proposed herein is just a preferable example for the purpose of illustrations only, not intended to limit the scope of the invention, so it will be apparent to those skilled in the art that various modifications and variation can be made in the present invention without departing from the spirit or scope of the invention.

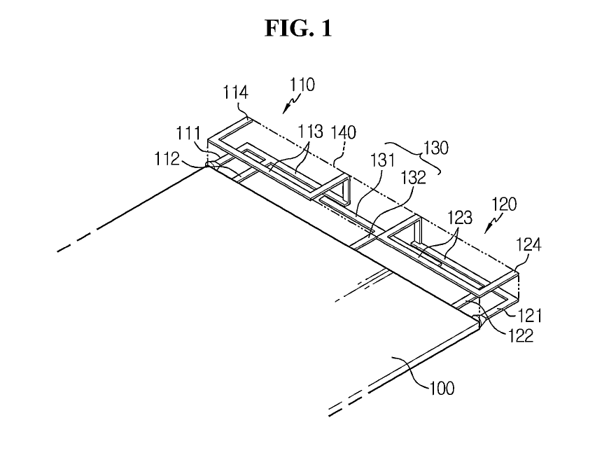

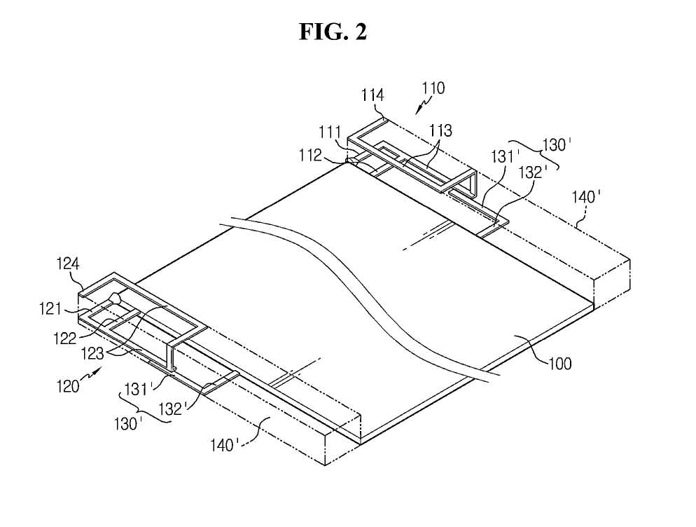

FIG. 1 is a perspective view illustrating a MIMO/diversity antenna with high isolation according to an embodiment of the present invention. FIG. 2 is a perspective view illustrating a MIMO/diversity antenna with high isolation according to another embodiment of the present invention.

As shown in FIGS. 1 and 2, a MIMO/diversity antenna with high isolation according to the present invention includes a printed circuit board 100, a plurality of antenna elements 110 and 120, a current conversion element 130 and 130′, and a dielectric block 140 and 140′.

Referring to FIG. 1, a MIMO/diversity antenna with high isolation according to an embodiment of the present invention includes a printed circuit board 100, a first antenna element 110 located at one end of the printed circuit board 100, a second antenna element 120 located at the other end of the printed circuit board 100, a current conversion element 130 connected with a common ground of the printed circuit board 100 apart from the first and second antenna elements 110 and 120 at a predetermined distance, and a dielectric block 140 having a predetermined dielectric constant where the first and second antenna elements 110 and 120 and the current conversion element 130 are formed and fixed.

The printed circuit board 100 has electronic components mounted thereon to perform various functions of a mobile communication terminal, in particular, for example, a power supply to supply power to the first and second antenna elements 110 and 120 and a common ground to commonly ground the first and second antenna elements 110 and 120 and the current conversion element 130. The common ground may be formed by patterning a metal material on one surface of the printed circuit board 100. However, the present invention is not limited to a specific pattern of the common ground.

The first and second antenna elements 110 and 120 are formed on the single dielectric block 140 located at one side of the printed circuit board 100 together with the current conversion element 130, and arranged symmetrically relative to the current conversion element 130.

The first antenna element 110 includes a first power line 111 connected with the power supply located at the left end of the printed circuit board 100, a first ground line 112 connected with the ground located at the common ground of the printed circuit board 100, and a first antenna pattern 113 connected with the first power line 111 and the first ground line 112 to radiate an electromagnetic wave to the outside.

The second antenna element 120 includes a second power line 121 connected with the power supply located at the right end of the printed circuit board 100, a second ground line 122 connected with the ground located at the common ground of the printed circuit board 100, and a second antenna pattern 123 connected with the second power line 121 and the second ground line 122 to radiate an electromagnetic wave to the outside.

Here, each of the first and second antenna patterns 113 and 123 has a length equal to one fourth of a wavelength λ at the center frequency of the operating frequency range of the antenna, respectively. Also, the first and second antenna patterns 113 and 123 are formed on the dielectric block 140 in three dimensions. The first and second antenna patterns 113 and 123 run from the first and second power lines 111 and 121 to the left and right ends of the printed circuit board 100 through at least one bending. The first and second antenna patterns 113 and 123 have ends 114 and 124 located at the left and right ends of the printed circuit board 100. In this instance, the ends 114 and 124 of the first and second antenna patterns 113 and 123 are arranged on the plane parallel to the plane where the first and second power lines 111 and 121 are arranged.

The first and second antenna elements 110 and 120 are connected with external signal circuits via the first and second power lines 111 and 121 to perform a function of the MIMO/diversity antenna, in particular, to receive electrical signals from the signal circuits and transmit different electromagnetic waves or to receive different electromagnetic waves from the outside and transmit to the signal circuits. Because the first and second power lines 111 and 121 are located at the left and right ends of the printed circuit board 100 and the ends 114 and 124 of the first and second antenna patterns 113 and 123 are arranged on the plane parallel to the plane where the first and second power lines 111 and 121 are arranged, an electric current through the common ground of the printed circuit board 100 may flow from the lower right end of the printed circuit board 100 to the upper left end or from the lower left end of the printed circuit board 100 to the upper right end.

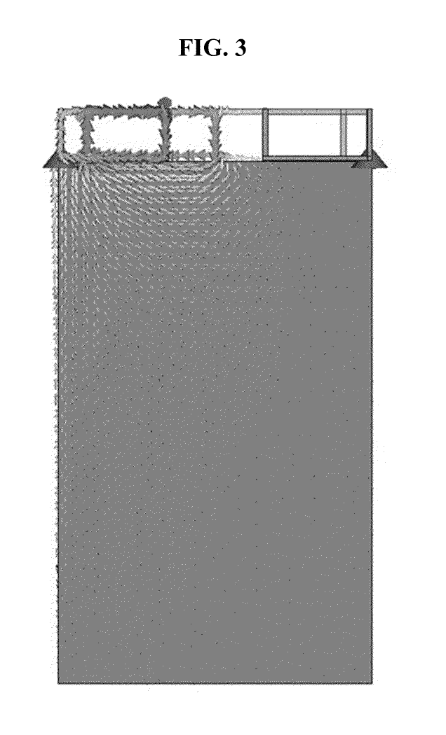

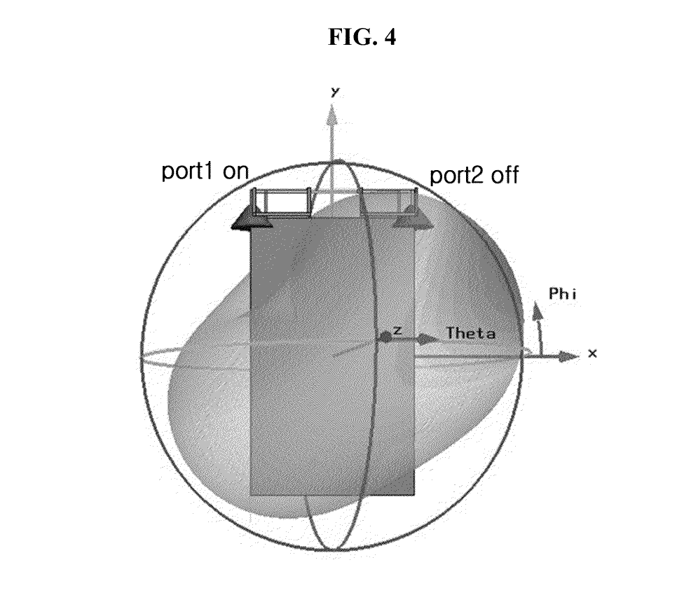

FIG. 3 is a view illustrating an electric current distribution on the common ground of the printed circuit board 100 when the operating frequency of 700 to 800 MHz bands is applied to the first antenna element 110 of the MIMO/diversity antenna according to an embodiment of the present invention. FIG. 4 is a view illustrating a 3-dimensional radiation pattern for the entire antenna when the operating frequency of 700 to 800 MHz bands is applied to the first antenna element 110 of the MIMO/diversity antenna according to another embodiment of the present invention.

As seen through FIGS. 3 and 4, when the operating frequency of 700 to 800 MHz bands is applied the first antenna element 110 via the first power line 11 of the MIMO/diversity antenna according to an embodiment of the present invention, an electric current through the common ground of the printed circuit board 100 flows from the lower right end of the printed circuit board 100 to the upper left end. This antenna pattern is shown in FIG. 4. Because the first and second antenna elements 110 and 120 are symmetrical, the antenna patterns of the first and second antenna elements 110 and 120 are perpendicular to each other, thereby ensuring low correlation (ECC) between the first and second antenna elements 110 and 120.

The current conversion element 130 is formed between the first and second antenna elements 110 and 120 on the single dielectric block 140 located at one side of the printed circuit board 100. Also, the current conversion element 130 is connected with the common ground of the printed circuit board 100 apart from the first and second antenna elements 110 and 120 at a predetermined distance.

The current conversion element 130 has a length equal to one tenth to one twentieth of a wavelength λ at the center frequency of the operating frequency range of the antenna, and is formed in the ‘T’ shape as a whole. The current conversion element 130 includes a current coupling pattern 131 coupled with the first and second antenna elements 110 and 120 and a current ground line 132 to connect the current coupling pattern 131 with the common ground of the printed circuit board 100.

The current coupling pattern 131 is arranged parallel to the first and second antenna patterns 113 and 123 of the first and second antenna elements 110 and 120. Also, the current coupling pattern 131 is coupled with the first and second antenna patterns 113 and 123 to absorb an electric current from the first and second antenna patterns 113 and 123. In this instance, the current coupling pattern 131 partially overlaps with the first and second antenna patterns 113 and 123 on the plane different from the plane where the first and second antenna patterns 113 and 123 are arranged. However, the present invention is not limited in this regard. The current coupling pattern 131 may be spaced apart from the first and second antenna patterns 113 and 123 on the same plane.

The current ground line 132 is arranged parallel to the first and second ground lines 112 and 122 of the first and second antenna elements 110 and 120. Also, the current ground line 132 is connected with the current coupling pattern 131 to induce an electric current from the first and second antenna elements 110 and 120 into the first and second ground lines 112 and 122 of the first and second antenna elements 110 and 120 again by applying the electric current absorbed by the current coupling pattern 131 to the common ground of the printed circuit board 100.

As described above, the current conversion element 130 induces an electric current from the first and second antenna elements 110 and 120 into the first and second antenna elements 110 and 120 again via the common ground, thereby improving the isolation between the first and second antenna elements 110 and 120. In other words, the current conversion element 130 induces an electric current from the first antenna pattern 113 of the first antenna element 110 into the first ground line 112 of the first antenna element 110 again while preventing an electric current flowing to the second antenna element 120. Also, the current conversion element 130 induces the electric current induced from the second antenna pattern 123 of the second antenna element 120 into the second ground line 122 of the second antenna element 120 again while preventing the electric current from flowing to the first antenna element 110. By inducing an electric current from the first and second antenna elements 110 and 120 into the first and second antenna elements 110 and 120 again via the current conversion element 130, the performance of the antenna can improve.

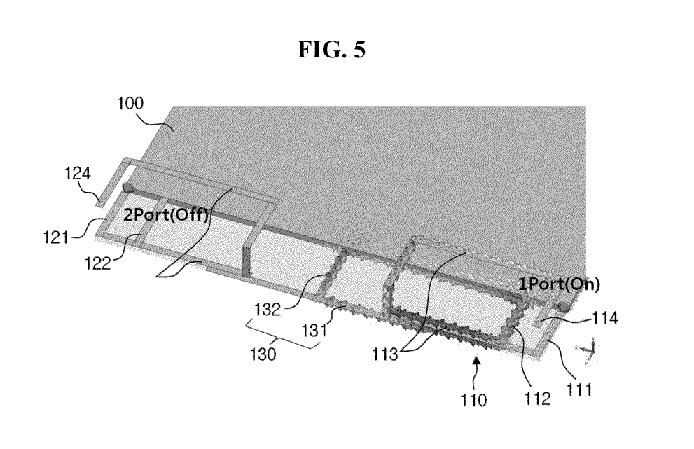

FIG. 5 is a view illustrating an electric current distribution on the first and second antenna elements 110 and 120 and the current conversion element 130 when the operating frequency of 700 to 800 MHz bands is applied to the first antenna element 110 of the MIMO/diversity antenna according to an embodiment of the present invention.

As shown in FIG. 5, when the operating frequency of 700 to 800 MHz bands is applied to the first power line 111 of the first antenna element 110 of the MIMO/diversity antenna according to an embodiment of the present invention, an electric current flows to the first antenna pattern 113 via the first ground line 112 and then to the end 114 of the first antenna pattern 113. In this instance, an electric current from the first antenna pattern 113 is absorbed by the current coupling pattern 131 of the current conversion element 130, and then applied to the common ground of the printed circuit board 100 via the current ground line 132 and thereby induced into the first ground line 112 again. Because an electric current from the first and second antenna elements 110 and 120 is induced into an operating antenna again without applying to the opposite antenna element, the isolation between the first and second antenna elements 110 and 120 and the performance of the antenna can improve.

Accordingly, the MIMO/diversity antenna according to the present invention can have low correlation and high isolation between the first and second antenna elements 110 and 120. Thus, when an interval between the first and second antenna elements 110 and 120 is equal to or larger than one twentieth of a wavelength λ at the center frequency of the operating frequency range of the antenna, the MIMO/diversity antenna functions as an antenna. Also, the current conversion element 130 used to improve the isolation between the first and second antenna elements 110 and 120 is smaller in size than the conventional art because the current conversion element 130 has a length equal to one tenth to one twentieth of a wavelength λ at the center frequency of the operating frequency range of the antenna. Accordingly, the MIMO/diversity antenna achieves the minimization such that the MIMO/diversity antenna according to the present invention can be implemented in a narrow internal space of a mobile communication terminal, and can operate in the low frequency range where a state-of-the-art next-generation wireless communication service, such as, for example, long term evolution (LTE) is provided.

Although this embodiment shows the first and second antenna elements 110 and 120 formed on the signal dielectric block 140 at the same side of the printed circuit board 100, the present invention is not limited in this regard. Various modifications and variations may be made according to alternative embodiments. A MIMO/diversity antenna according to another embodiment of the present invention is illustrated in FIG. 2.

As shown in FIG. 2, the MIMO/diversity antenna with high isolation according to another embodiment of the present invention includes a printed circuit board 100, a first antenna element 110 located at one side of the printed circuit board 100, a second antenna element 120 located at the other side of the printed circuit board 100, a current conversion element 130′ provided individually at each of the first and second antenna elements 110 and 120, and a dielectric block 140′ having a predetermined dielectric constant provided individually to each of the opposite sides of the printed circuit board 100 to individually fix each of the first and second antenna elements 110 and 120 and the current conversion element 130′.

The first and second antenna elements 110 and 120 are symmetrical relative to the printed circuit board 100. The first and second antenna elements 110 and 120 have first and second power lines 111 and 121 at the opposite sides of the printed circuit board 100 and first and second ground lines 112 and 122 located closer to the inside than the first and second power lines 111 and 121, respectively.

The current conversion element 130′ is individually provided to each of the first and second antenna elements 110 and 120 and forms a bent bar as a whole. The current conversion element 130′ extends to the first and second antenna elements 110 and 120, and is spaced apart from first and second antenna patterns 113 and 123 at a predetermined distance. The current conversion element 130′ includes a current coupling pattern 131′ coupled with the first and second antenna patterns 113 and 123 and a current ground line 123′ to connect the current coupling pattern 131′ with the common ground of the printed circuit board 100.

The MIMO/diversity antenna of this embodiment is substantially the same as the previous embodiment except that the first antenna element 110 is located at one side of the printed circuit board 100 and the second antenna element 120 is located at the other side of the printed circuit board 100. This structure further increases the interval between the first and second antenna elements 110 and 120 and thus allows applications requiring high isolation of the antenna.

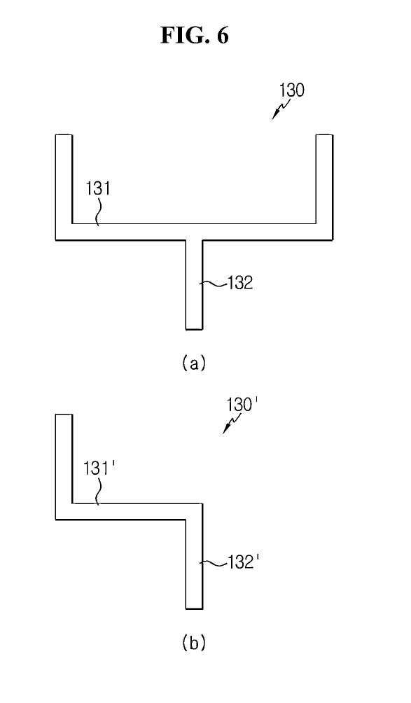

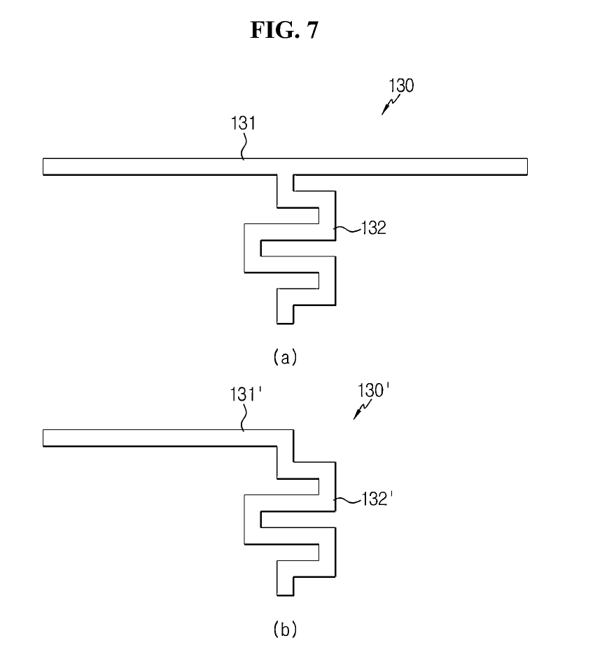

FIGS. 6 and 7 are plane views illustrating modified examples of the current conversion element according to the present invention.

Various modifications and variations may be made on the current conversion element 130 and 130′ of FIGS. 1 and 2. For example, as shown in FIG. 6, the current coupling pattern 131 and 131′ of the current conversion element 130 and 130′ is bent. In this case, the current coupling pattern 131 and 131′ can be spaced apart from the first and second antenna patterns 113 and 123 of the first and second antenna elements 110 and 120 on the same plane. As shown in FIG. 7, the current ground line 132 and 132′ of the current conversion element 130 and 130′ meanders. In this case, the current ground line 132 and 132′ increases in length to improve the spatial utilization in a narrow space.

Although the present invention has been described hereinabove, it should be understood that the detailed description and specific examples, while indicating preferred embodiments of the invention, are given by way of illustration only, since various changes and modifications within the spirit and scope of the invention will become apparent to those skilled in the art from this detailed description.

What is claimed is:

1. A MIMO/diversity antenna comprising:
a printed circuit board;
a plurality of antenna elements;
a current conversion element connected with a common ground of the printed circuit board apart from the antenna elements at a predetermined distance,
wherein the current conversion element is coupled with the antenna elements to induce an electric current from the antenna elements into the antenna elements again via the common ground.

2. The MIMO/diversity antenna according to claim 1,
wherein each of a plurality of the antenna elements includes:
a power line connected with a power supply located at the end of the printed circuit board;
a ground line connected with a ground located on the common ground of the printed circuit board; and
an antenna pattern connected with the power line and the ground line to radiate an electromagnetic wave to the outside.

3. The MIMO/diversity antenna according to claim 2,
wherein the antenna pattern is formed by at least one bending and has an end located at the end of the printed circuit board.

4. The MIMO/diversity antenna according to claim 3,
wherein the end of the antenna pattern is arranged parallel to the ground lines of the antenna elements on the same or different plane.

5. The MIMO/diversity antenna according to claim 1,
wherein each of a plurality of the antenna elements has a length equal to one fourth of a wavelength λ at the center frequency of the operating frequency range of the antenna.

6. The MIMO/diversity antenna according to claim 1,
wherein a plurality of the antenna elements are symmetrical and spaced apart from each other at a distance equal to at least one twentieth of a wavelength λ at the center frequency of the operating frequency range of the antenna.

7. The MIMO/diversity antenna according to claim 1,
wherein the current conversion element includes:
a current coupling pattern coupled with the antenna elements; and
a current ground line to connect the current coupling pattern with the common ground of the printed circuit board.

8. The MIMO/diversity antenna according to claim 7,
wherein the current coupling pattern is partially bent and parallel to the antenna patterns of the antenna elements.

9. The MIMO/diversity antenna according to claim 8,
wherein the current coupling pattern partially overlaps with the antenna patterns of the antenna elements on the same or different plane.

10. The MIMO/diversity antenna according to claim 7,
wherein the current ground line is parallel to the ground lines of the antenna elements.

11. The MIMO/diversity antenna according to claim 7,
wherein the current ground line meanders.

12. The MIMO/diversity antenna according to claim 1,
wherein the antenna elements and the current conversion element are connected with the same surface of the printed circuit board, or
the antenna elements are connected with one surface of the printed circuit board and the current conversion element is connected with the other surface of the printed circuit board.

13. The MIMO/diversity antenna according to claim 1,
wherein the current conversion element has a length equal to one tenth to one twentieth of a wavelength λ at the center frequency of the operating frequency range of the antenna.

14. The MIMO/diversity antenna according to claim 1,
wherein a plurality of the antenna elements and the current conversion element are formed in the space or formed and fixed on a dielectric block having a predetermined dielectric constant.

15. A MIMO/diversity antenna comprising:
a printed circuit board;
a first antenna element located at one end of the printed circuit board;
a second antenna element located at the other end of the printed circuit board; and
a current conversion element connected with a common ground of the printed circuit board and located between the first and second antenna elements apart from the first and second antenna elements at a predetermined distance and,
wherein the current conversion element is coupled with the first and second antenna elements to induce an electric current from the first and second antenna elements into the first and second antenna elements again via the common ground.

16. The MIMO/diversity antenna according to claim 15,
wherein the first and second antenna elements are symmetrical relative to the current conversion element and the current conversion element is formed in the shape of ‘T’.

17. The MIMO/diversity antenna according to claim 15,
wherein the first and second antenna elements include:
power lines located at the opposite ends of the printed circuit board; and
ground lines located between the power lines of the first and second antenna elements.

18. A MIMO/diversity antenna comprising:
a printed circuit board;
a first antenna element located at one side of the printed circuit board;
a second antenna element located at the other side of the printed circuit board; and
a current conversion element connected with a common ground of the printed circuit board and individually provided to each of the first and second antenna elements apart from the first and second antenna elements at a predetermined distance and,
wherein the current conversion element is coupled with the first and second antenna elements to induce an electric current from the first and second antenna elements into the first and second antenna elements again via the common ground.

19. The MIMO/diversity antenna according to claim 18,
wherein the first and second antenna elements are symmetrical relative to the current conversion element and the current conversion element is formed in the shape of a bar bent at a right angle.

20. The MIMO/diversity antenna according to claim 18,
wherein the first and second antenna elements include:
power lines located at the ends of the opposite sides of the printed circuit board; and
ground lines located closer to the inside than the power lines.
